(19) United States
(12) Patent Application Publication
(10) Pub. No.: US 2026/0021772 A1
(43) Pub. Date: Jan. 22, 2026

(54) DRAWER ARRANGED ADJACENT BOX SIDE STEP

(71) Applicant: Ford Global Technologies, LLC, Dearborn, MI (US)

(72) Inventors: Matthew Craddock, Dearborn, MI (US); John Galin, Mill Valley, CA (US); Gregory Marquardt, Ann Arbor, MI (US); Todd Bucher, Brownstown, MI (US); Jeremy R. Leng, Ypsilanti, MI (US)

(21) Appl. No.: 18/775,394

(22) Filed: Jul. 17, 2024

(51) Int. Cl. B60R 9/02; B60R 3/00

(52) U.S. Cl. CPC B60R 9/02; B60R 3/002

(57) ABSTRACT

A motor vehicle may include a cargo box including an outer panel, a box side step, and a drawer arranged adjacent the box side step. The drawer is moveable between a closed position and an open position. The drawer includes a drawer front panel facing laterally outward, and, relative to when the drawer is in the closed position, at least a portion of the drawer front panel is recessed laterally inward of the outer panel.

### TECHNICAL FIELD

This disclosure relates to a drawer arranged adjacent a box side step of a motor vehicle, such as a pickup truck.

### BACKGROUND

Pickup trucks typically include a latching tailgate that swings between an upright, closed position and a horizontal, open position. When in the closed position, the tailgate is latched to a cargo box. When open, the tailgate provides access to the cargo box from the rear of the pickup truck. Some pickup trucks incorporate a side step adjacent a side of the cargo box which can be used by a user to access the cargo box from the side of the pickup truck.

### SUMMARY

In some aspects, the techniques described herein relate to a motor vehicle, including: a cargo box including an outer panel; a box side step; and a drawer arranged adjacent the box side step and moveable between a closed position and an open position, wherein the drawer includes a drawer front panel facing laterally outward, wherein, relative to when the drawer is in the closed position, at least a portion of the drawer front panel is recessed laterally inward of the outer panel.

In some aspects, the techniques described herein relate to a motor vehicle, wherein, relative to when the drawer is in the closed position: a first portion of the drawer front panel is recessed laterally inward of the outer panel, and a second portion of the drawer front panel is substantially flush with the outer panel.

In some aspects, the techniques described herein relate to a motor vehicle, wherein the first portion exhibits a length substantially equal to a length of the box side step.

In some aspects, the techniques described herein relate to a motor vehicle, wherein: the box side step projects partially laterally outward of a portion of the outer panel adjacent the box side step, and relative to when the drawer is in the closed position, the first portion is recessed laterally inward of the outer panel such that an entire uppermost surface of the box side step is exposed.

In some aspects, the techniques described herein relate to a motor vehicle, wherein, relative to when the drawer is in the closed position, the entirety of the drawer front panel is recessed laterally inward of the outer panel.

In some aspects, the techniques described herein relate to a motor vehicle, wherein: the drawer includes a drawer back panel spaced-apart from the drawer front panel by a first drawer side panel, a second drawer side panel, and a drawer bottom panel, and the first and second drawer side panels project from opposite sides of the drawer bottom panel.

In some aspects, the techniques described herein relate to a motor vehicle, wherein the drawer bottom panel includes a drain assembly configured to permit fluid to drain out of the drawer via the drain assembly.

In some aspects, the techniques described herein relate to a motor vehicle, wherein: the drawer includes first and second slides configured to facilitate sliding of the drawer between the open and closed positions, and the first and second slides are mounted adjacent (i) the first drawer side panel and the second drawer side panel, or (ii) the drawer bottom panel.

In some aspects, the techniques described herein relate to a motor vehicle, wherein: the drawer includes a divider within a drawer box, and the divider includes at least two compartments.

In some aspects, the techniques described herein relate to a motor vehicle, wherein the divider includes four compartments.

In some aspects, the techniques described herein relate to a motor vehicle, further including a light configured to emit light into the drawer when the drawer is in the open position.

In some aspects, the techniques described herein relate to a motor vehicle, further including a lock assembly configured to selectively hold the drawer in the closed position.

In some aspects, the techniques described herein relate to a motor vehicle, wherein the drawer includes a mechanically or electrically actuated latch.

In some aspects, the techniques described herein relate to a motor vehicle, wherein: the drawer is slidable relative to a cavity formed in the cargo box, a seal extends around a perimeter of the cavity, and a laterally inward surface of the drawer front panel is configured to press against the seal when the drawer is in the closed position.

In some aspects, the techniques described herein relate to a motor vehicle, wherein the box side step is vertically between a ground surface and the drawer.

In some aspects, the techniques described herein relate to a motor vehicle, wherein the box side step is forward of a rear wheel well of the motor vehicle.

In some aspects, the techniques described herein relate to a motor vehicle, wherein: the outer panel is one of a first outer panel and a second outer panel of the cargo box, the box step is a first box step corresponding to the first outer panel, the motor vehicle includes a second box step corresponding to the second outer panel, the drawer is a first drawer, the motor vehicle includes a second drawer arranged adjacent the second box step, and the second drawer exhibits a lesser volume capacity than the first drawer.

In some aspects, the techniques described herein relate to a motor vehicle, wherein the second drawer and second box step are arranged on the same side of the motor vehicle as a fuel door or charging port door of the motor vehicle.

In some aspects, the techniques described herein relate to a motor vehicle, wherein the motor vehicle is a pickup truck.

In some aspects, the techniques described herein relate to a method, including: sliding a drawer between a closed position and an open position, wherein, relative to when the drawer is in the closed position, at least a portion of a drawer front panel is recessed laterally inward of an outer panel of a cargo box of a motor vehicle, and wherein the drawer is arranged adjacent a box side step of the motor vehicle.

### BRIEF DESCRIPTION OF THE DRAWINGS

FIG. 1 is a side view of a motor vehicle including a box side step and a drawer adjacent the box side step. In FIG. 1, the vehicle is a pickup truck.

FIG. 2 is a perspective view illustrating additional detail of the drawer and the box side step. In FIG. 2, the drawer is in the closed position.

FIG. 3 is a perspective view illustrating additional detail of the drawer and the box side step. In FIG. 3, the drawer is in the open position.

FIG. 4 illustrates a first arrangement of slides relative to the drawer.

FIG. 5 illustrates a second arrangement of slides relative to the drawer.

FIG. 6 illustrates the drawer including a handle configured to cooperate with a mechanical latch.

FIG. 7 illustrates the drawer including a first button configured to cooperate with an electrical latch.

FIG. 8 illustrates the drawer including a second button configured to cooperating with an electrical latch.

FIG. 9 illustrates the drawer configured to function with a push-to-open latch mechanism.

FIG. 10 illustrates an example divider for use with the drawer.

FIG. 11 illustrates a first lock arrangement for the drawer.

FIG. 12 illustrates an example drain assembly for the drawer.

FIG. 13 illustrates an example drawer on an opposite side of the vehicle as the drawer of FIG. 2.

FIG. 14 illustrates another configuration of the front drawer panel.

### DETAILED DESCRIPTION

This disclosure relates to a drawer arranged adjacent a box side step of a motor vehicle, such as a pickup truck. The drawer of this disclosure provides users with convenient storage for various items, including tow straps, ropes, wheel chocks, chains, etc., without taking up space in the cargo bed or passenger compartment of the motor vehicle. The drawer is also located adjacent a box side step, and is configured so as to not inhibit normal use of the box side step. The configuration of the drawer is such that the box side step may be relatively large while minimizing the amount that the box side step projects laterally outwards of the vehicle. The drawer also adds to the overall aesthetic appeal of the motor vehicle. These and other benefits will be appreciated from the following description.

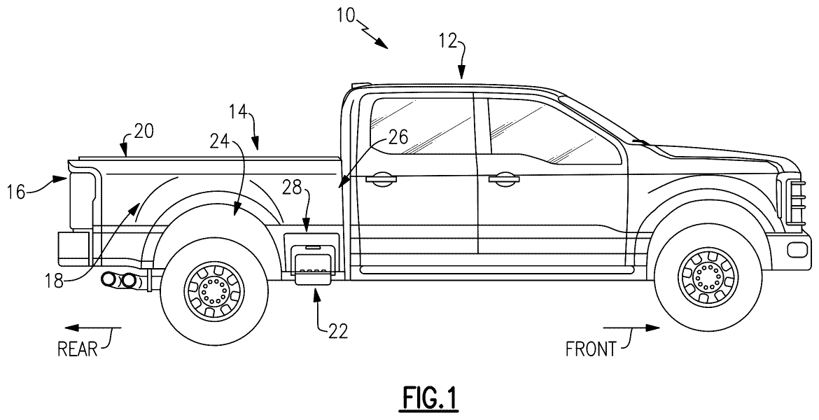

FIG. 1 illustrates a motor vehicle 10 (“vehicle 10”), which in this example is a pickup truck. The vehicle 10 includes a passenger cabin 12 and a cargo box 14 rearward of the passenger cabin 12. The “front” and “rear” directions are labeled in FIG. 1 for ease of reference. The vehicle 10 further includes a tailgate 16 configured to move between an open position and a closed position to allow access to the cargo box 14 from the rear of the vehicle 10. Along the sides, the cargo box 14 includes first and second side rails 18, 20. From the view of FIG. 1, the tailgate 16 and the second side rail 20 are not visible. When in the closed position, the tailgate 16 is configured to latch relative to the first and second side rail 18, 20. While a pickup truck is shown in FIG. 1, this disclosure extends to other types of vehicles.

In this disclosure, the vehicle 10 includes at least one box side step, which is a step that can be used by a user to access the cargo box 14 from the side of the vehicle 10. One box side step 22 is visible in FIG. 1. The box side step 22 is arranged adjacent, and in particular is attached to, the first side rail 18. It should be understood that the second side rail 20 may also include a substantially similar box side step. The term box side step refers to the surface where a user places their foot/shoe to access the cargo box 14 and the corresponding components of the box side step. In this sense, the term box side step refers to an overall box side step assembly.

The box side step 22, in this example, is forward of a rear wheel well 24 of the vehicle 10. The box side step 22 is also rearward of a front panel 26 of the cargo box 14. The box side step 22 may be vertically aligned with at least a rear portion of a running board of the vehicle 10, which may increase the ease of using the box side step 22.

The vehicle 10 further includes a drawer 28 arranged adjacent the box side step 22. The drawer 28 is slidable between a closed position and an open position to reveal a drawer box, which can store items therein. The drawer 28 is arranged adjacent, and in particular, is vertically above the box side step 22. The box side step 22, in this example, is vertically beneath the drawer 28, and in particular is vertically between the drawer 28 and a ground surface adjacent the vehicle 10. While one drawer 28 is shown in FIG. 1, it should be understood that another drawer may be arranged adjacent a box side step on the second side rail 20 of the vehicle 10. As will be discussed below, if two such drawers are present on the motor vehicle 10, the volume capacity of the two drawers may differ.

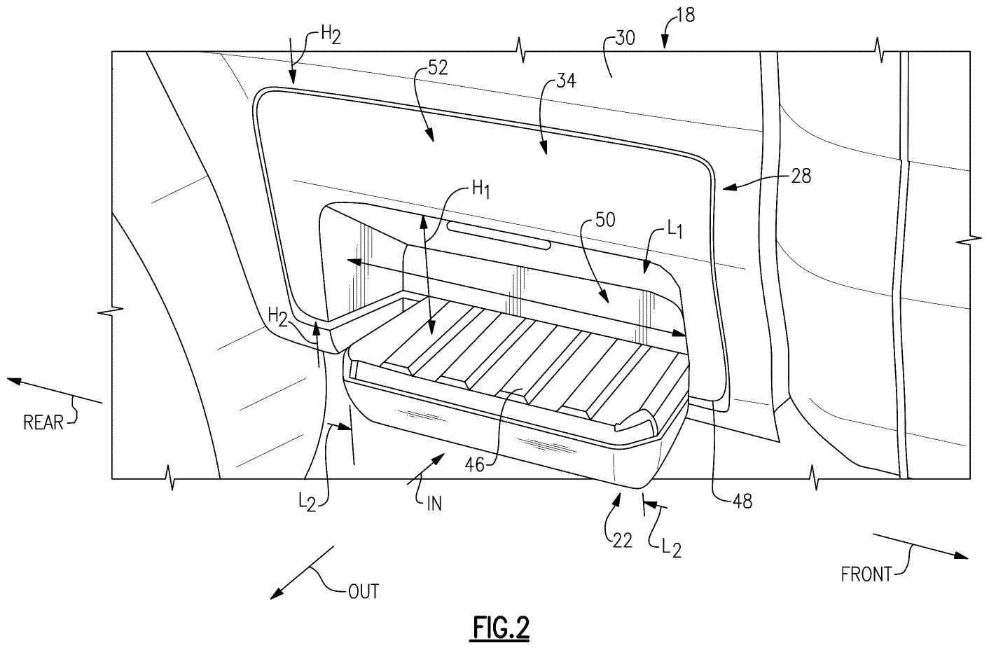

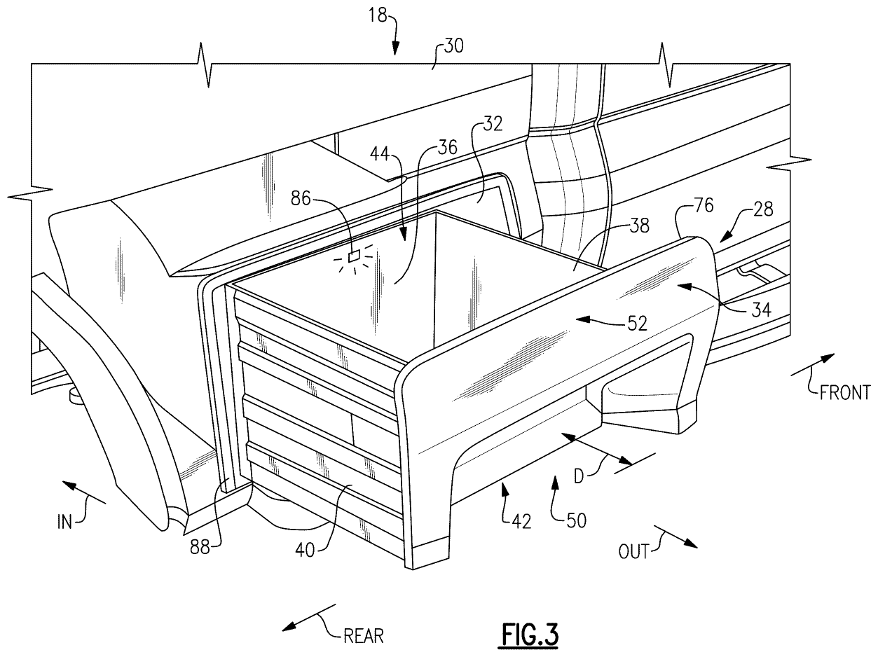

FIGS. 2 and 3 illustrate the box side step 22 and the drawer 28 in more detail, with the drawer 28 in the closed position and open position, respectively. In this disclosure, the first and second side rails 18, 20 include inner and outer panels that are laterally spaced-apart from one another in a direction normal to the centerline of the vehicle 10. The “in” and “out” directions are labeled in some drawings, and are representative of laterally inward and laterally outward directions, respectively. The laterally inward and laterally outward directions are normal to the centerline of the vehicle 10. In FIGS. 2 and 3, the outer panel 30 of the first side rail 18 is shown. The outer panel 30 provides an outer body panel of the vehicle 10.

The drawer 28 is slidable relative to the outer panel 30. In particular, the drawer 28 is slidable in and out of a cavity 32 formed in the outer panel 30. The cavity 32 is sized and shaped to correspond to the size and shape of the drawer 28.

The drawer 28 includes a drawer front panel 34, a drawer back panel 36 spaced-apart from the drawer front panel 34 by a first drawer side panel 38, a second drawer side panel 40, and a drawer bottom panel 42. The first and second drawer side panels 38, 40 project from opposite sides of the drawer bottom panel 42. The directional terms used herein relative to the panels of the drawer 28 are with reference to a user facing the drawer 28 standing on a side of the vehicle 10 and viewing the drawer 28. For instance, the drawer front panel 34 faces the laterally outward direction of the vehicle 10 and is perceived as a front of the drawer 28 from a perspective a user standing on a laterally outward side of the vehicle 10. The drawer front panel 34 is spaced-apart from the drawer rear panel 36 in the laterally outward direction of the vehicle 10. The first and second drawer side panels 38, 40 are spaced-apart from one another in the “front” and “rear” directions of the vehicle 10.

The drawer front panel 34, drawer back panel 36, first drawer side panel 38, second drawer side panel 40, and drawer bottom panel 42 define a drawer box 44 configured to hold items therein. The drawer box 44 is accessible from a top when the drawer 28 is in the open position of FIG. 3. In other configurations, the drawer box 44 could be accessible from a direction other than the top.

The box side step 22 is configured to support a user while a foot of the user is placed on the box side step 22, for example, to facilitate access to items in or near the cargo box 14. The box side step 22 in this example is arranged vertically beneath the drawer 28, and in particular an uppermost surface 46 of the box side step 22 is arranged vertically beneath a bottommost edge 48 of the drawer front panel 34. In this example, the uppermost surface 46 of the box side step 22 includes a textured top surface. The box side step 22 is configured such that only a portion of the uppermost surface 46 projects laterally outward of an adjacent portion of the outer panel 30.

The drawer front panel 34, in this disclosure, is configured to facilitate access to the box side step 22. In particular, at least a portion of the drawer front panel 34 is recessed laterally inward of the outer panel 30 when the drawer 28 is in the closed position.

With reference to when the drawer 28 is in the closed position of FIG. 2, the drawer front panel 34 includes a first portion 50 recessed laterally inward of the outer panel 30. Further, a second portion 52 of the drawer front panel 34 is substantially flush with the outer panel 30. In this example, the second portion 52 is arranged above the first portion 50, forward of the first portion 50, and rearward of the first portion 50. The second portion 52 is not beneath the first portion 50.

The first portion 50 includes a height H1 and a length L1. The height H1 corresponds to a height of a standard foot of a user. The length L1 is substantially equal to, and in one example is slightly greater than, a length L2 of the box side step 22. The first portion 50 is recessed by a depth D relative to the second portion 52, as perhaps best seen in FIG. 3. In this way, when the drawer 28 is closed, an entirety of the uppermost surface 46 of the box side step 22 is exposed such that a user can place their foot on the uppermost surface 46. By providing the drawer 28 with the recessed first portion 50, the area of the uppermost surface 46 of the box side step 22 can be relatively large while minimizing the amount that the box side step 22 projects laterally outward of the outer panel 30.

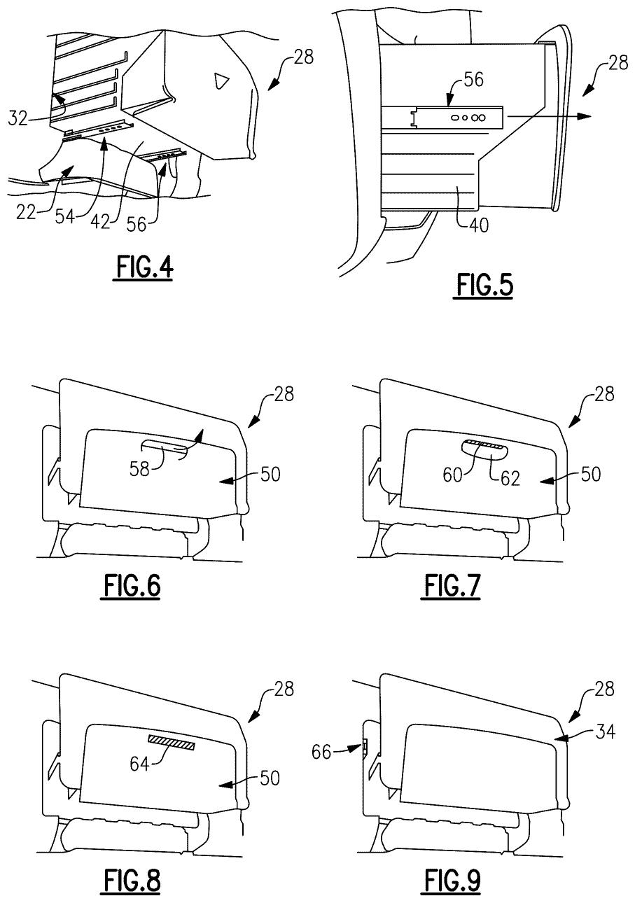

In an aspect of this disclosure, the drawer 28 includes first and second slides configured to facilitate sliding the drawer 28 relative to the cavity 32 between the closed and open positions. In FIG. 4, first and second slides 54, 56 are arranged between the drawer bottom panel 42 and the cavity 32. The first and second slides 54, 56 may be provided by any known assembly or mechanism configured to facilitate relative sliding of a drawer relative to a cavity. Each of the first and second slides 54, 56 may include a track, one or more rollers, and one or more slide members configured to slide within the track.

While the first and second slides 54, 56 are shown mounted relative to the drawer bottom panel 42, the first and second slides 54, 56 may alternatively be mounted to the first and second drawer side panels 38, 40 as generally represented in FIG. 5. As shown in FIG. 5, the second slide 56 is mounted relative to the second drawer side panel 40. The first slide 54 (not shown in FIG. 5) is likewise mounted relative to the first drawer side panel 38 (not visible in FIG. 5).

FIGS. 6-9 illustrate various handles and/or buttons configured to work with mechanical or electrical latch arrangements for the drawer 28. The drawer 28 can include a mechanically or electrically actuated latch. As used herein, a mechanical latch is configured to selectively hold the drawer 28 closed using only mechanical components. An electrical latch is configured to selectively hold the drawer 28 closed using a combination of mechanical and electrical components.

In FIG. 6, the drawer 28 includes a mechanical latch activated as a handle 58 is pulled in the lateral outward direction to permit the drawer 28 to open. The handle 58 could activate an electrical latch in another example. In FIG. 7, the drawer 28 includes an electrically actuated latch configured to permit the drawer 28 to open when a button 60, which is arranged in a recess 62 and faces the generally laterally inward direction, is pressed. In FIG. 8, an electrically actuated latch is configured to permit the drawer 28 to open when a laterally-outward facing button 64 is pressed. The handle 58 and buttons 60, 64 of FIGS. 6-8 are centered along the drawer 28, relative to the front and rear directions of the vehicle 10, and are located adjacent a top of the first portion 50. In FIG. 9, the drawer 28 is configured to open when a force is applied to the drawer front panel 34 so as to activate a mechanical push-to-open latch 66.

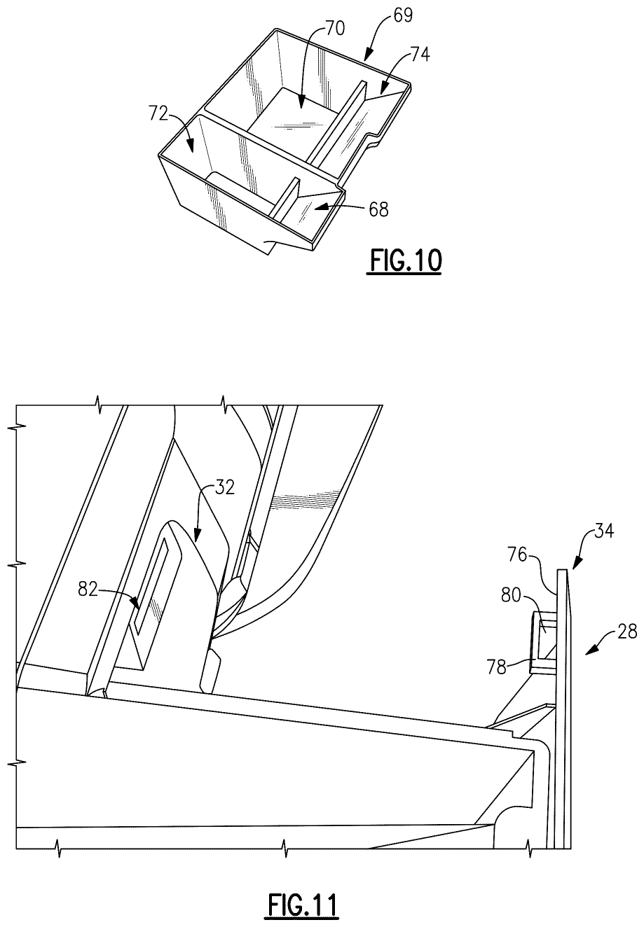

FIG. 10 illustrates an example divider 69 configured to be received within the drawer box 44. In this example, the divider 69 includes four compartments 68, 70, 72, 74. Compartments 68 and 74 are arranged vertically above the recessed first portion 50, in this example, and therefore exhibit a lesser depth than compartments 70, 72. In this example, each of the compartments exhibits a different volume capacity than each of the other compartments. While four compartments are shown, this disclosure extends to dividers having two or more compartments.

In addition to or as an alternative to one of the aforementioned latches, the drawer 28 may include a lock assembly configured to hold the drawer in the closed position. As one example, represented in FIG. 11, a laterally-inward facing surface 76 of the drawer front panel 34 may include a projection 78 defining an opening 80. In this example, a centerline of the opening 80 is substantially perpendicular to a ground surface adjacent the vehicle 10. When the drawer 28 is in the closed position, the projection 78 may project into a slot 82 formed in the cavity 32. When the projection is in the slot 82, a lock assembly may be selectively activated such that another projection projects into the opening 80 and prevents the drawer 28 from opening, until the lock assembly is unlocked and the projection is withdrawn from the opening 80. The lock assembly may be locked and unlocked in response to a user pressing a button within the passenger cabin 12, on a keyfob, or on a mobile device, as examples.

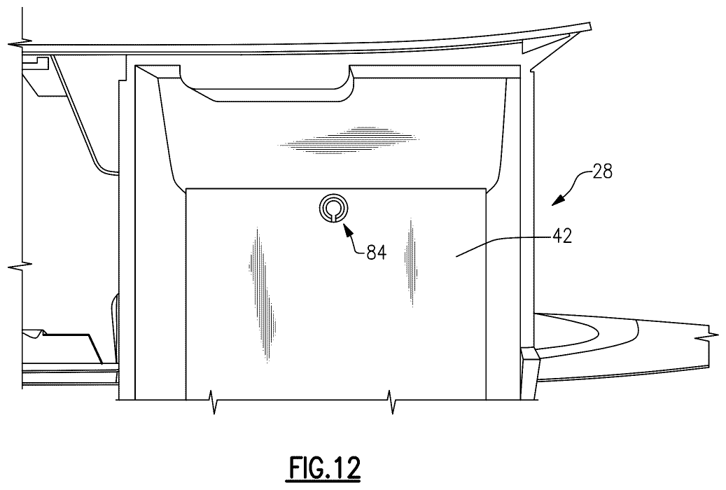

In another aspect of this disclosure, the drawer 28 includes a drain assembly configured to permit fluid, such as water, to drain out of the drawer 28. As shown in FIG. 12, a drawer bottom panel 42 includes a drain assembly 84. The drain assembly 84 includes an opening in this example. In another example, the drain assembly 84 includes a plug configured to selectively plug the opening.

In another aspect of this disclosure, a light 86 (FIG. 3) is configured to emit light into the drawer box 44 when the drawer 28 is in the open position. In FIG. 3, the light 86 is mounted relative to the drawer rear panel 36. The light 86 could be mounted to another surface of the drawer 28, the cavity 32, or the outer panel 30 in other examples.

In another aspect of this disclosure, a seal 88 (FIG. 3) extends about the perimeter of the cavity 32. The seal 88 may be made of an elastomeric material. The surface 76 of the drawer front panel 34 is configured to press against the seal 88 when the drawer is in the closed position.

As mentioned above, the second rail 20 of the vehicle 10 could also include a drawer 90, as shown in FIG. 13. The drawer 90 may be configured similar to the drawer 28, reflected about the centerline of the vehicle 10, with the only exception being that the drawer 28 exhibits a greater height dimension H2 (FIG. 2) than the height dimension H3 of the drawer 90. In turn, the drawer 28 exhibits a greater volume capacity (i.e., space for storing items within the drawer) than a volume capacity of the drawer 90. In this example, the height dimension H3 is lesser than the height dimension H2 to facilitate arranging the drawer 90 vertically beneath a fuel door or a charging port door, as indicated at reference numeral 92.

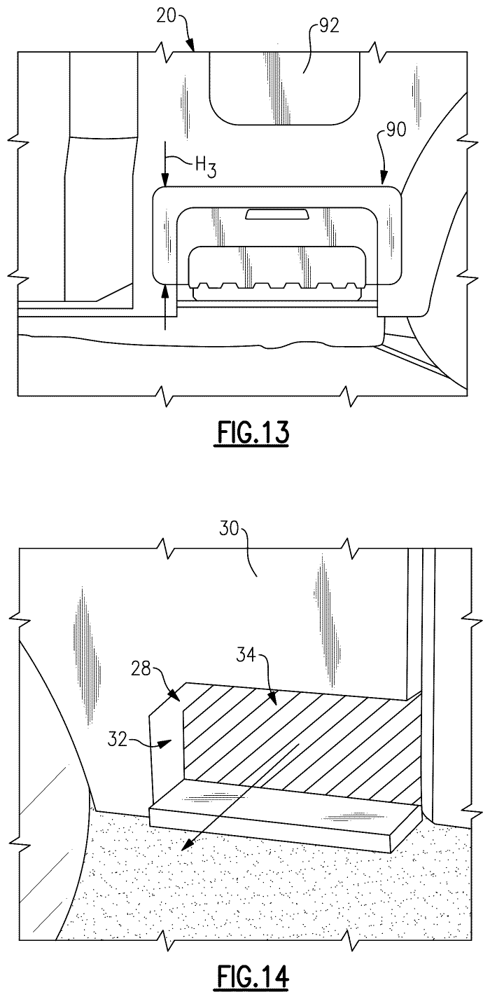

While in the above-discussed embodiments the drawer front panel 34 includes a portion (i.e., second portion 52) that is substantially flush with the outer panel 30 when the drawer 28 is in the closed position, the drawer 28 (or the drawer 90) may include a drawer front panel 34 that is entirely recessed laterally inward of the outer panel 30 when the drawer 28 is in the closed position, as shown in FIG. 14. The embodiment of FIG. 14 would work with any of the latches of FIGS. 6-9, but may be particularly suited for use with the push-to-open latch mechanism of FIG. 9.

It should be understood that terms such as “about,” “substantially,” and “generally” are not intended to be boundaryless terms, and should be interpreted consistent with the way one skilled in the art would interpret those terms. Further, directional terms such as “front,” “rear,” “laterally inward,” “laterally outward,” “top,” “bottom,” “side,” etc., are used for purposes of explanation only and should not otherwise be construed as limiting.

Although the different examples have the specific components shown in the illustrations, embodiments of this disclosure are not limited to those particular combinations. It is possible to use some of the components or features from one of the examples in combination with features or components from another one of the examples. In addition, the various figures accompanying this disclosure are not necessarily to scale, and some features may be exaggerated or minimized to show certain details of a particular component or arrangement.

One of ordinary skill in this art would understand that the above-described embodiments are exemplary and non-limiting. That is, modifications of this disclosure would come within the scope of the claims. Accordingly, the following claims should be studied to determine their true scope and content.

1. A motor vehicle, comprising:
a cargo box including an outer panel;
a box side step; and
a drawer arranged adjacent the box side step and moveable between a closed position and an open position, wherein the drawer includes a drawer front panel facing laterally outward, wherein, relative to when the drawer is in the closed position, at least a portion of the drawer front panel is recessed laterally inward of the outer panel.

2. The motor vehicle as recited in claim 1, wherein, relative to when the drawer is in the closed position:
a first portion of the drawer front panel is recessed laterally inward of the outer panel, and a second portion of the drawer front panel is substantially flush with the outer panel.

3. The motor vehicle as recited in claim 2, wherein the first portion exhibits a length substantially equal to a length of the box side step.

4. The motor vehicle as recited in claim 3, wherein:
the box side step projects partially laterally outward of a portion of the outer panel adjacent the box side step, and
relative to when the drawer is in the closed position, the first portion is recessed laterally inward of the outer panel such that an entire uppermost surface of the box side step is exposed.

5. The motor vehicle as recited in claim 1, wherein, relative to when the drawer is in the closed position, the entirety of the drawer front panel is recessed laterally inward of the outer panel.

6. The motor vehicle as recited in claim 1, wherein:
the drawer includes a drawer back panel spaced-apart from the drawer front panel by a first drawer side panel, a second drawer side panel, and a drawer bottom panel, and
the first and second drawer side panels project from opposite sides of the drawer bottom panel.

7. The motor vehicle as recited in claim 6, wherein the drawer bottom panel includes a drain assembly configured to permit fluid to drain out of the drawer via the drain assembly.

8. The motor vehicle as recited in claim 6, wherein:
the drawer includes first and second slides configured to facilitate sliding of the drawer between the open and closed positions, and
the first and second slides are mounted adjacent (i) the first drawer side panel and the second drawer side panel, or (ii) the drawer bottom panel.

9. The motor vehicle as recited in claim 6, wherein:
the drawer includes a divider within a drawer box, and
the divider includes at least two compartments.

10. The motor vehicle as recited in claim 9, wherein the divider includes four compartments.

11. The motor vehicle as recited in claim 1, further comprising a light configured to emit light into the drawer when the drawer is in the open position.

12. The motor vehicle as recited in claim 1, further comprising a lock assembly configured to selectively hold the drawer in the closed position.

13. The motor vehicle as recited in claim 1, wherein the drawer includes a mechanically or electrically actuated latch.

14. The motor vehicle as recited in claim 1, wherein:
the drawer is slidable relative to a cavity formed in the cargo box,
a seal extends around a perimeter of the cavity, and
a laterally inward surface of the drawer front panel is configured to press against the seal when the drawer is in the closed position.

15. The motor vehicle as recited in claim 1, wherein the box side step is vertically between a ground surface and the drawer.

16. The motor vehicle as recited in claim 1, wherein the box side step is forward of a rear wheel well of the motor vehicle.

17. The motor vehicle as recited in claim 1, wherein:
the outer panel is one of a first outer panel and a second outer panel of the cargo box,
the box step is a first box step corresponding to the first outer panel,
the motor vehicle includes a second box step corresponding to the second outer panel,
the drawer is a first drawer,
the motor vehicle includes a second drawer arranged adjacent the second box step, and
the second drawer exhibits a lesser volume capacity than the first drawer.

18. The motor vehicle as recited in claim 17, wherein the second drawer and second box step are arranged on the same side of the motor vehicle as a fuel door or charging port door of the motor vehicle.

19. The motor vehicle as recited in claim 1, wherein the motor vehicle is a pickup truck.

20. A method, comprising:
sliding a drawer between a closed position and an open position, wherein, relative to when the drawer is in the closed position, at least a portion of a drawer front panel is recessed laterally inward of an outer panel of a cargo box of a motor vehicle, and wherein the drawer is arranged adjacent a box side step of the motor vehicle.
